(19) United States
(12) Patent Application Publication
(10) Pub. No.: US 2019/0183251 A1
(43) Pub. Date: Jun. 20, 2019

(54) SUPPORT PANEL, BED ASSEMBLY AND MOUNTING METHOD

(71) Applicant: LOGICDATA Electronic & Software Entwicklungs GmbH, DEUTSCHLANDSBERG (AT)

(72) Inventors: Haymo NIEDERKOFLER, GRAZ (AT); Walter KOCH, SCHWANBERG (AT)

(21) Appl. No.: 16/099,681

(22) PCT Filed: May 12, 2017
(86) PCT No.: PCT/EP2017/061489

§ 371 Date: Nov. 7, 2018

Related U.S. Application Data
(60) Provisional application No. 62/335,296, filed on May 12, 2016.

(51) Int. Cl. A47C 20/04; A47C 21/04; A47C 21/00; A61G 7/015; A61G 7/05; A61G 7/018; H01R 13/631; H01R 33/97; H01R 33/88

(52) U.S. Cl. CPC A47C 20/041; A61G 2210/90; A47C 21/042; A47C 21/003; A61G 7/015; A61G 7/0527; A61G 7/018; H01R 13/631; H01R 33/97; H01R 33/88; A61G 2203/34; A61G 2203/30; A61G 2203/46; A61G 2203/36; A61G 2210/70; A47C 21/048

(57) ABSTRACT

A support panel (16) is provided comprising a base member (11), the base member (11) being the mechanically stabilizing component of the support panel (11), at least one mechanical coupler (18) on the base member (11), an identifier which can electronically be read out through the at least one second electrical connector (28), at least one second electrical connector (28) located on the base member (11), and at least one functional module (34) selected from a sensor, an actuator, a control unit, an electrical link, and a power supply, wherein the at least one mechanical coupler (18) and the at least one second electrical connector (28) are designed for reversible mechanical and electrical connection to a bed frame assembly (30), and wherein a top surface (17) of the support panel (16), opposite to the bottom surface (15), is designed to be applied with a mattress (20).

This application claims the benefit of U.S. Provisional Application No. 62/335,296, filed May 12, 2016, which is incorporated herein by reference in its entirety.

A support panel for a bed frame assembly is provided as well as a bed assembly comprising such a support panel.

Document U.S. Pat. No. 5,771,511 A refers to a communication network for a hospital bed.

A problem to be solved is to provide a support panel that can easily be connected and disconnected with a bed frame assembly.

This problem is solved inter alia by a support panel and a bed assembly with the features of the independent claims. Advantageous further embodiments are provided in the dependent claims.

According to at least one embodiment, the support panel is designed for reversible mechanical and electrical connection to a bed frame assembly.

According to at least one embodiment, the bed frame assembly comprises a base frame. The base frame is preferably the mechanically bearing component of the bed frame assembly. That is, all other components of the bed frame assembly can firmly be fixed to the base frame.

According to at least one embodiment, the base frame has a longitudinal axis. A person that intentionally uses the bed assembly lies along the longitudinal axis.

According to at least one embodiment, the bed frame assembly comprises one, two or more than two longitudinal beams. The longitudinal beams extend along the longitudinal axis. The longitudinal beams are designed to carry support panels for a mattress. Preferably, the at least one longitudinal beam is designed as described in document DE 10 2015 122 605 A1, the disclosure content of which is included by reference.

According to at least one embodiment, a plurality of mechanical fasteners is located on the longitudinal beams, preferably on top sides of each one of the longitudinal beams. By means of the mechanical fasteners, the at least one support panel can reversibly mechanically be connected to the bed frame assembly.

Beside just mechanical connection, it is possible that the mechanical fasteners and the mechanical couplers are designed to fulfil further tasks. For example, mechanical forces and/or momentums can be transferred from the bed frame assembly to the support panel and vice versa. Hence, the mechanical fasteners and the mechanical couplers can form a transmission shaft to transfer actuating power to the support panel, for example for actuators on the support panel.

According to at least one embodiment, the bed frame assembly comprises one or, preferably, a plurality of first electrical connectors. The at least one first electrical connector is applied to at least one of the longitudinal beams. It is possible, that one of the longitudinal beams is free of the first electrical connectors. As an alternative, all longitudinal beams are provided with one or a plurality of first electrical connectors.

According to at least one embodiment, the at least one first electrical connector is designed for reversible electrical connection to the at least one support panel. That is, the support panel can be electrically connected by means of the bed frame assembly, in particular only by means of the bed frame assembly.

In at least one embodiment, the bed frame assembly comprises a base frame having a longitudinal axis, at least two longitudinal beams extending along the longitudinal axis, a plurality of mechanical fasteners located on top sides of each one of the longitudinal beams, and at least one first electrical connector applied to at least one of the longitudinal beams. The mechanical fasteners and the at least one first electrical connector are designed for reversible mechanical and electrical connection to a support panel for a mattress.

According to at least one embodiment, the bed frame assembly comprises a plurality of the first electrical connectors. In this case, it is possible that each one of the longitudinal beams or only one of the longitudinal beams bears the first electrical connectors.

According to at least one embodiment, the longitudinal beams each comprise a plurality of individual pieces. Preferably, at least some of the individual pieces are electrically movable for example by actuators relative to the base frame. Hence, in the intended use of the bed frame assembly, the individual pieces and, hence, the support panels can have different heights and positions relative to each other. The individual pieces and the support panels are preferably reversible movable.

According to at least one embodiment, some or each one of the individual pieces is provided with one, two or more than two of the mechanical fasteners. Hence, the support panels can exactly be positioned on the individual pieces.

According to at least one embodiment, each one of the individual pieces of at least one of the longitudinal beams is provided with at least one of the first electrical connectors. It is possible that all individual pieces of all longitudinal beams comprise at least one of the first electrical connectors.

According to at least one embodiment, the mechanical fasteners as well as the first electrical connectors are located on the top sides of the longitudinal beams. Hence, it is possible that with mechanical connection also electrical connection is achieved. Thus, a separate electrical connection can be avoided.

According to at least one embodiment, the first electrical connectors are integrated with the mechanical fasteners. For example, the mechanical fasteners are designed like robust plug sockets.

According to at least one embodiment, the at least one first electrical connector is located on a side face of the respective longitudinal beam. Said side face can face the adjacent longitudinal beam. It is possible in this case that the first electrical connector is not visible from outside the bed assembly.

Thus, separate mechanical and electrical connection can be achieved. Hence, the at least one first electrical connector can be designed to be connected separately from the mechanical fasteners.

According to at least one embodiment, the bed frame assembly further comprises a controller module. The controller module is designed to provide electrical power and/or control signals to the at least one first electrical connector. It is thus possible that the support panels are supplied with electrical power and/or control signals by the controller module.

According to at least one embodiment, the controller module is firmly connected on the base frame and/or to the longitudinal beams and/or to the individual parts. In this case, the controller module can be a central controller by means of which all electrical components of the bed assembly may be addressed.

According to at least one embodiment, the control concept is a decentral concept. In this case, there is no need for a central controller module. For example, each one or some or all of the support panels comprise a control unit. It is possible that other components of the bed assembly comprise a control unit, too. Preferably, the at least two control units are interconnected by electrical links, in particular a bus system, in order to form a network. Preferably, the bus system allows bi-directional communication and electrical power supply.

According to at least one embodiment, the controller module and/or the at least one control unit comprises a power supply. It is also possible that there is a separate power supply, in particular, if there is no central controller module.

According to at least one embodiment, the controller module is arranged on a separate board of the bed frame assembly or is integrated in a part of the bed frame assembly. For example, the controller module can be integrated in the or in one of the longitudinal beams. The same can be true for the power supply and, with view to the support panel, for the control unit. Otherwise, the controller module and/or the power supply can be loosely arranged with the other parts of the bed frame assembly.

According to at least one embodiment, the controller module and the power supply are two distinct components. These components can be arranged on or in a board or another part of the bed frame assembly, in particular the longitudinal beams.

According to at least one embodiment, the controller module and the power supply are loosely arranged with the remaining parts of the bed frame assembly. For example, these components can be designed to be arranged on a ground floor.

According to at least one embodiment, the mechanical fasteners as well as the first electrical connectors are designed as plug-in devices to be handled without any help of tools. That is, the support panels can preferably mounted and removed with bare hands.

According to at least one embodiment, the longitudinal beams are electrically interconnected. This can be done, for example, by one or more cables. A wireless connection is also possible.

Further, a support panel for such a bed frame assembly is provided. Hence, features for the bed frame assembly are also disclosed for the support panel, and vice versa.

According to at least one embodiment, the support panel comprises a base member. Preferably, the base member is the mechanically stabilizing component of the support panel. The support panel can be a massive board. It is also possible that the support panel is formed as a lamella or as a plurality of interconnected lamella, for example as part of a lath floor. Moreover, the base member may be formed as a rod or as a grid or as a fence.

According to at least one embodiment, the support panel comprises one or a plurality of mechanical couplers, preferably on a bottom surface or on at least one side surface of the base member. The at least one mechanical coupler is designed to be reversibly connected with the at least one mechanical fastener, in particular in a one-to-one manner.

According to at least one embodiment, the support panel comprises a one or more second electrical connectors. Preferably, the at least one or all second electrical connectors are located on the bottom surface. The at least one second electrical connector is designed to be electrically and optionally also mechanically connected with the at least one first electrical connector. In particular, the first and second electrical connectors are to be connected in a one-to-one manner.

According to at least one embodiment, the at least one mechanical coupler and the at least one second electrical connector are designed for reversible mechanical and electrical connection to the bed frame assembly. Thus, the support panel can preferably be attached to and removed from the bed frame assembly without the use of tools.

According to at least one embodiment, the at least one mechanical coupler as well as the at least one second electrical connector enable a mechanical and electrical mounting of the support panel in a direction parallel to the bottom surface or alternatively orthogonal to the bottom surface. The terms parallel and orthogonal in this case can have a tolerance of at most 5° or 10° or 15° to the exact meaning of parallel or orthogonal. That is, the support panel can be purposefully mounted on the bed frame by moving the support panel in parallel to the bottom surface or elsewise by moving it orthogonal to the bottom surface. If the support panel does not have an extended bottom surface or has a non-planar bottom surface, the bearing plane for the mattress on the support panel may be used to define the mounting direction instead.

According to at least one embodiment, the support panel can be attached to the bed frame assembly without the use of tools but removed from the bed frame assembly only with the use of a tool. In this case, too, the removal of the support panel is preferably non-destructive.

According to at least one embodiment, a top surface of the support panels, opposite to the bottom surface, is designed to be applied with a mattress. That is, a mattress can be applied to the at least one support panels, preferably to a plurality of support panels.

According to at least one embodiment, the support panel comprises one or a plurality of identifiers. The at least one identifier can electronically be read out through the at least one second electrical connector. By means of the identifier, it can preferably be electronically read out what kind of support panel is used and/or at which position the support panel is located in the bed frame assembly. For example, the identifier includes information about the at least one functional module. The identifier allows to automatically determine which actuators, sensors and so on are used in the at least one functional module. The identifier can be distinct and/or unique. It is possible that the identifier is of digital manner and/or includes a bit sequence. By way of example, the identifier is or is included in an IC like an ASIC or in a memory, particularly a ROM like an EPROM. The identifier can be a separate component, however, preferably the identifier is included in another electronic component of the support panel like the functional module, in particular is included in the control unit.

In at least one embodiment, the support panel comprises a base member, the base member being the mechanically stabilizing component of the support panel. The support panel further comprises one or a plurality of mechanical couplers in particular on a bottom surface or on at least one side surface of the base member, and at least one second electrical connector located on the bottom surface or on the at least one side surface. An identifier can electronically be read out through the at least one second electrical connector. The at least one mechanical coupler and the at least one second electrical connector are designed for reversible mechanical and electrical connection to the bed frame assembly. A top surface of the support panels, opposite to the bottom surface, is designed to be applied with a mattress. Further, the support panel comprises at least one functional module which is selected from a sensor, an actuator, a control unit, an electrical link, and a power supply.

According to at least one embodiment, the support panel further comprises one or more functional modules. The at least one functional module can preferably be powered electrically. The functional module can electrically be connected with the at least one second electrical connector.

According to at least one embodiment, the functional module is completely or in part located on the bottom surface. It is also possible that the at least one functional module is completely or in part located within the support panel, that is, for example, within a cut-out or a cavity of the base member. Further, it is possible that the at least one functional module is completely or in part located on at least one lateral face the support panel. In particular, a part of the at least one functional module is located on the bottom surface and a part is located in the base member.

According to at least one embodiment, the functional module includes at least one of a massage module, a heating module, a cooling module, a lighting element module, and at least one sensor module. There can be one or more sensor modules for example to sense acceleration, pressure, humidity, temperature and/or brightness. Further, the sensor can be a biometrical sensor, for example to sense a pulse rate and/or a breathing rage. Alternatively or in addition, the functional module can include a wireless communication module, a USB port, a microphone, a telephone, a cordless phone, a loudspeaker, and/or a squeeze protection module.

According to at least one embodiment, the at least one mechanical coupler is accessible from the side of the top surface. In addition or as an alternative, the at least one mechanical coupler is accessible from at least one lateral face. Hence, to mount or dismount the support panels it can be avoided to work from a bottom side of the bed frame assembly. For example, the mechanical coupler is a plug. The mechanical coupler can also be a clamp, that can reach from the bottom surface via the lateral face to the top surface.

According to at least one embodiment, the support panel further comprises a third electrical connector. The one or the more third electrical connectors are designed to electrically connect two adjacent support panels with each other. In particular, there are two third electrical connectors on opposing edges of the support panels. Hence, by means of the third electrical connectors a plurality of support panels can be electrically interconnected along the longitudinal axis.

Further, a support panel for such a bed frame assembly is provided. Hence, features for the bed frame assembly are also disclosed for the support panel, and vice versa.

In at least one embodiment, the bed assembly comprises a bed frame assembly according to at least one of the previous embodiments and at least one support panel according to at least one of the previous embodiments. The at least one support panel is reversibly mechanically connected to the longitudinal beams by means of the mechanical fasteners and the mechanical couplers. The at least one support panel is reversibly electrically connected to the longitudinal beams by means of the at least one first and second electrical connectors.

Preferably, the bed assembly includes more than one support panel, for example at least three or ten and/or at most ten or twenty or thirty support panels.

Adjustable bed frames typically comprise a segmented surface, each portion movable independent of another. The surfaces can be converted to various positions such as inclining the upper body or raising the lower body. Typically, adjustable bed frames are manufactured in a particular arrangement that cannot be altered by the a consumer. Thus, if a consumer desires a different arrangement for their bed frame, the user is required to purchase a new bed frame, or continue to use a bed frame that the user is dissatisfied with.

In one aspect, aspects of the disclosure relate to a bed frame assembly including a base frame having a longitudinal axis including a set of connectors aligned with longitudinal axis, and preferably a controller module configured to connect with a power source and the set of connectors, and configured to selectively send control signals to the set of connectors.

In another aspect, aspects of the disclosure relate to a bed frame assembly including a base frame having a longitudinal axis including a set of connectors aligned with longitudinal axis, preferably a controller module configured to connect with a power source and the set of connectors, and configured to selectively send control signals to the set of first connectors, and at least one support panel extending across the base frame and having a mechanical attachment to the bed frame, and a second connector configured to interconnect with one of the set of first connectors when the at least one support panel is attached to the base frame, the second connector operably interconnected with a functional module. The functional module is operably controlled by the controller module when the at least one support panel is attached to the base frame.

In another aspect, the bed frame assembly comprises a base frame having a longitudinal axis including a set of connectors aligned with longitudinal axis, and a controller module configured to connect with a power source and the set of connectors, and configured to selectively send control signals to the set of connectors.

In another aspect, the functional module is a power supply module.

In another aspect, the at least one support panel includes at least one of lumbar support or headrest support.

In another aspect, the base frame further comprises a movable frame and a stationary frame, wherein the movable frame is configured to move relative to the stationary frame, and wherein the set of connectors is preferably disposed on the movable frame.

In another aspect, the base frame includes a set of mechanical fasteners and the at least one supporting panel include a set of mechanical couplers corresponding with the set of mechanical fasteners, wherein the set of mechanical fasteners and the set of mechanical couplers are preferably configured to selectively interconnect.

In another aspect, the set of mechanical couplers are twist connectors.

In another aspect, the bed frame assembly comprises a base frame having a longitudinal axis including a set of connectors aligned with longitudinal axis, a controller module configured to connect with a power source and the set of connectors, and configured to selectively send control signals to the set of first connectors, and at least one support panel extending across the base frame and having a mechanical attachment to the bed frame, and a second connector configured to interconnect with one of the set of first connectors when the at least one support panel is attached to the base frame, the second connector operably interconnected with a functional module. The functional module is operably controlled by the controller module when the at least one support panel is attached to the base frame.

Further, a mounting method to mount the support panel on the bed frame assembly is provided. Hence, features for the bed frame assembly and for the support panel are also disclosed for the mounting method, and vice versa.

Advantageous embodiments and developments of the bed assembly, the bed frame assembly and the support panel will become apparent from the exemplary embodiments described below in association with the figures. In the exemplary embodiments and figures, similar or similarly acting constituent parts are provided with the same reference symbols. The elements illustrated in the figures and their size relationships among one another should not be regarded as true to scale [unless otherwise indicated]. Rather, individual elements may be represented with an exaggerated size for the sake of better representability and/or for the sake of better understanding.

In the figures:

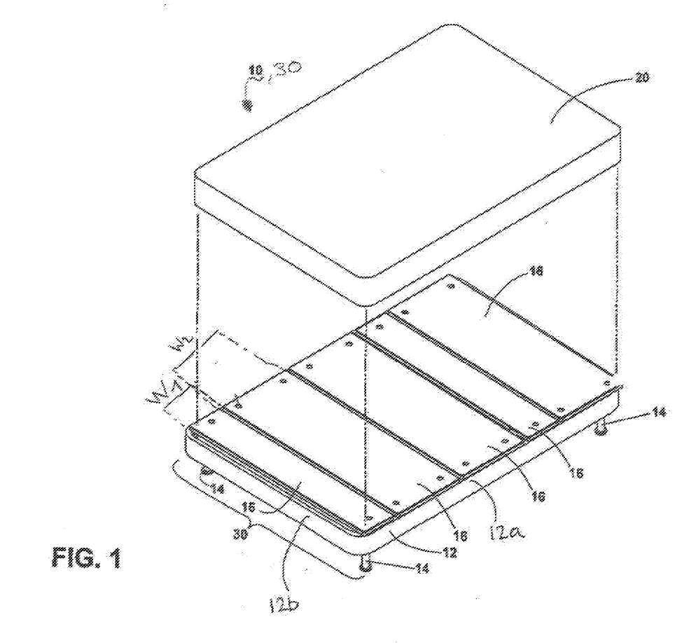

FIG. 1 is a perspective view of a bed assembly in accordance with various aspects described herein.

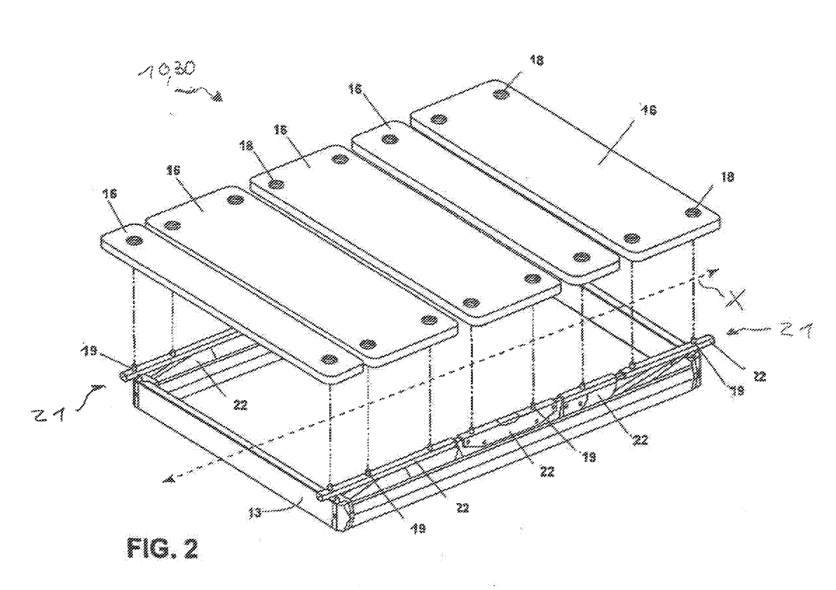

FIG. 2 is a perspective view of the bed frame assembly where the support panels have been removed from the longitudinal beams, in accordance with various aspects described herein.

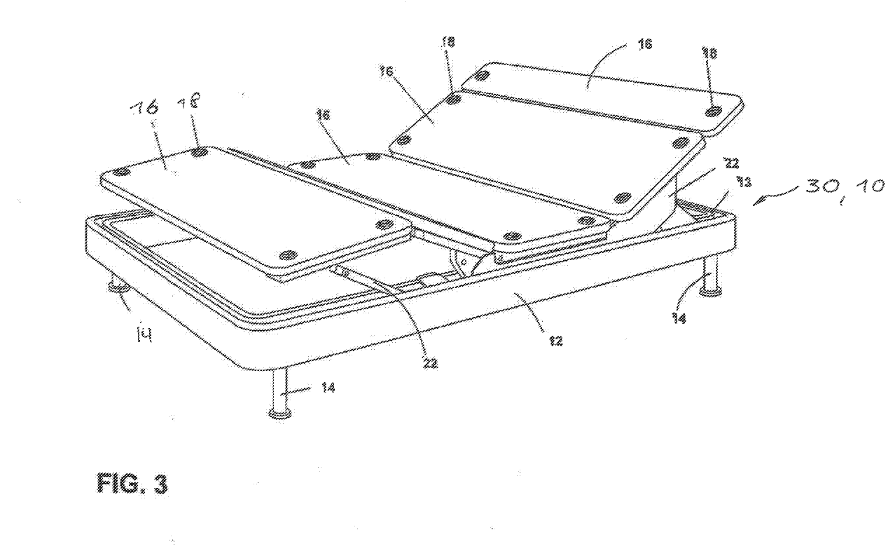

FIG. 3 is a perspective view of the bed frame assembly in an elevated position in accordance with various aspects described herein.

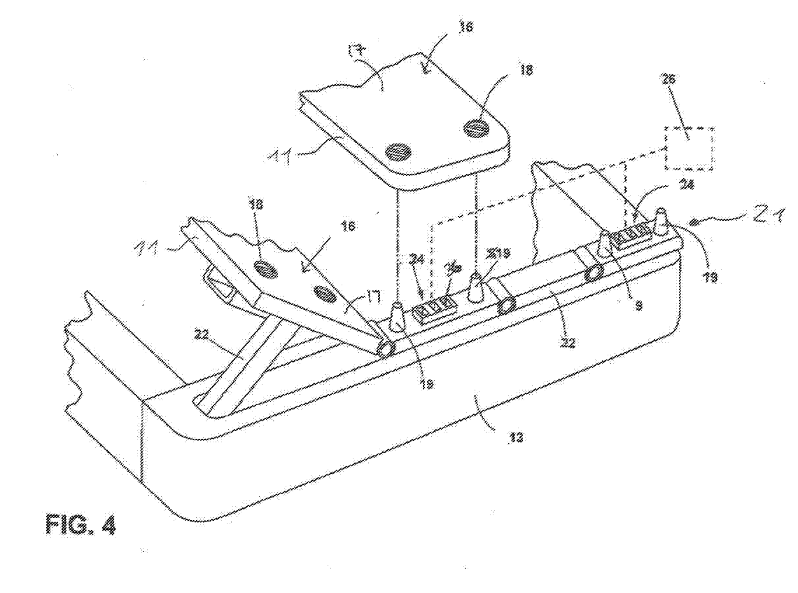

FIG. 4 is a partial perspective view of the bed frame assembly in accordance with various aspects described herein.

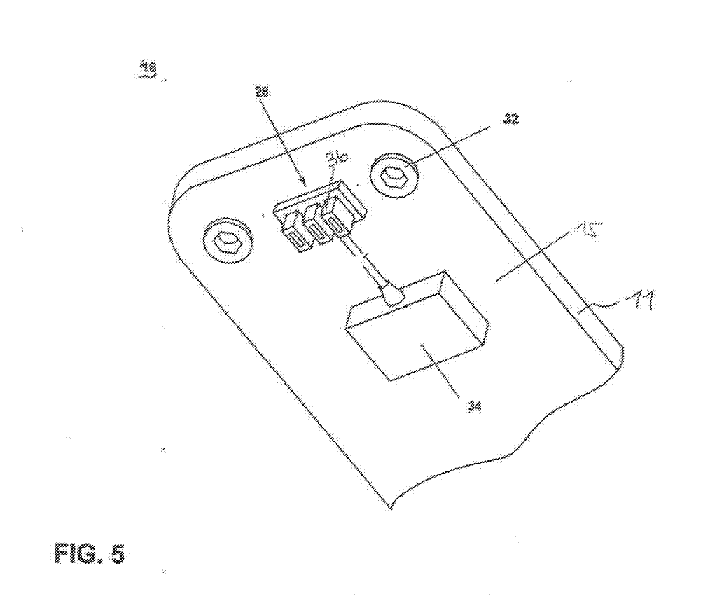

FIG. 5 is a partial bottom view of the support panel in accordance with various aspects described herein.

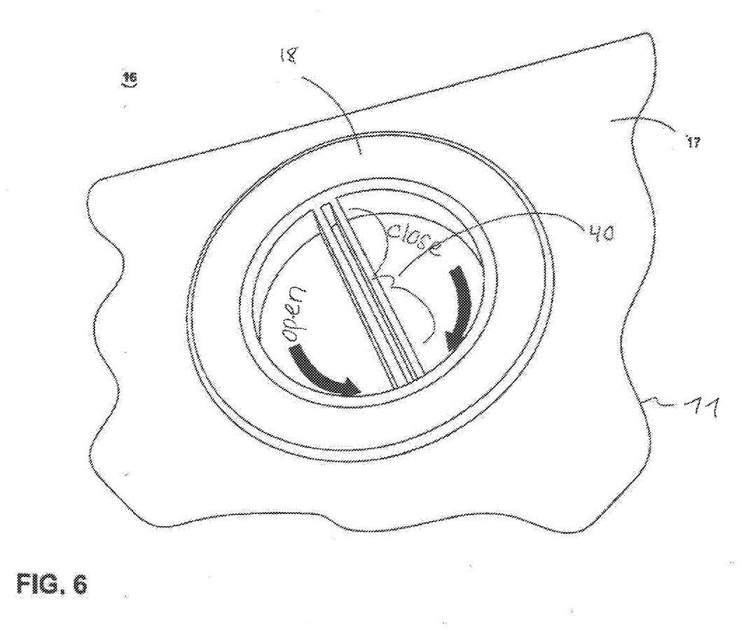

FIG. 6 is a top perspective view of a twist connector in accordance with various aspects described herein.

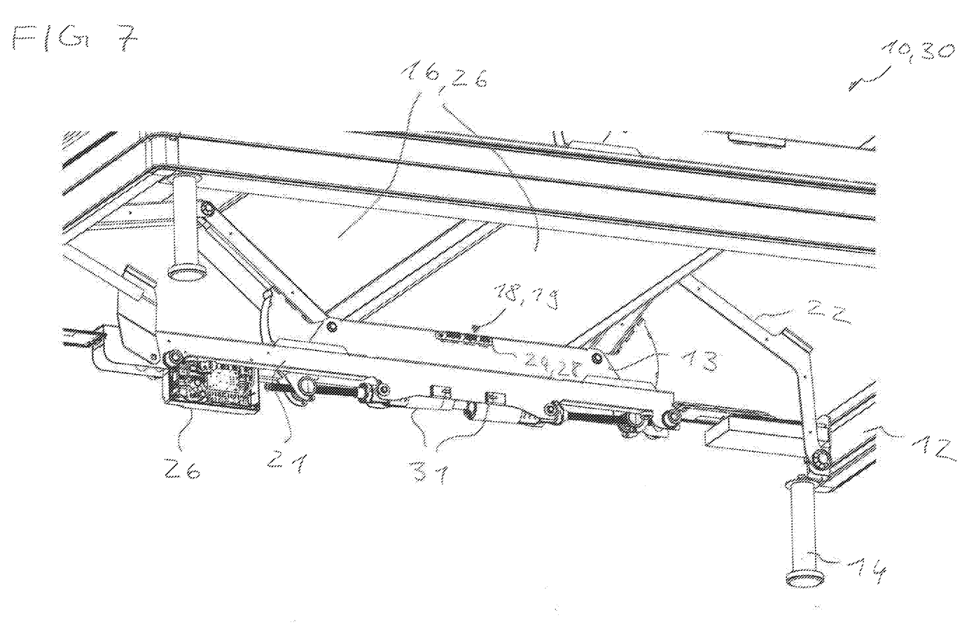

FIG. 7 is a partial perspective view of the bed frame assembly in accordance with various aspects described herein.

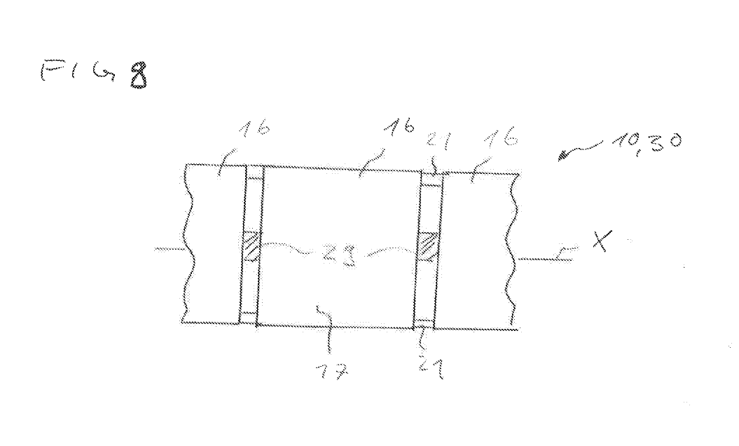

FIG. 8 is a top view of the bed assembly in accordance with various aspects described herein.

While “a set of” various elements will be described, it will be understood that “a set” can include any number of the respective elements, including only one element. The term “head” or “head section” refers to a longitudinal end of a bed frame assembly typically used by a user to rest their head, torso, or upper body. Conversely, the “foot” or “foot section” of the bed assembly refers to the opposing longitudinal end of the bed frame assembly typically used by a user to rest their feet, legs, or lower body. All directional references (e.g., head, foot, upper, lower, upward, downward, left, right, lateral, front, back, top, bottom, above, below, vertical, horizontal, clockwise, counterclockwise) are only used for identification purposes to aid the reader's understanding of the disclosure, and do not create limitations, particularly as to the position, orientation, or use thereof. Connection references (e.g. attached, coupled, connected, and joined) are to be construed broadly and can include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto can vary.

FIG. 1 illustrates a bed assembly 10. The bed assembly 10 comprises a bed frame assembly 30 and a mattress 20. The bed frame assembly 30 can include a base frame 12 having legs 14, and a set of support panels 16. The legs 14 are coupled with the base frame 12 and structurally support the base frame 12 such that the base frame 12 can be spaced from a floor or surface. The base frame 12 has a pair of parallel, spaced frame sections 12a extending in a longitudinal axis X of the bed assembly 10 and a pair of crossing portions 12b perpendicular to and coupled with frame sections 12a. The frame sections 12b can be, for example, located at opposing “head” and “foot” sections of the bed. The set of support panels 16 can be releasably or selectively coupled with or supported by the base frame 12.

The support panels 16 can have varying lengths and cover a subset of the area defined by the base frame 12. For example, as illustrated, a first support panel can have a first length extending along the longitudinal axis X of W₁, while a second support panel can have a second length extending along the longitudinal axis X of W₂, which is less than W₁. While the lengths of the support panels can vary, the cross-width of the set of support panels 16, that is, the width of the set of support panels 16 between the parallel spaced sections 12a, is selected to match the spacing between the parallel sections 12a.

For example, there can be at least one support panel, not shown, that protrudes beyond the longitudinal beams. Such support panels can be used as placement areas similar to a bedside table.

In non-limiting configurations of the disclosure, the lengths of the individual support panels 16 can be correlated to the parts of a user's body to which the individual support panel 16 is in alignment with or supports. For instance, non-limiting examples of support panels 16 can be tailored or selected to correspond with a head, a torso, a waist, legs, thighs, feet, and the like. Since a user's head is typically smaller than a user's torso, the length of the individual support panel 16 that supports a user's head can be smaller than the length of the individual support panel 16 that supports a user's torso.

The ability to select various lengths for individual support panels 16 allows for a user to easily customize a bed frame assembly 30 for comfort, ergonomics, or the like. While the set of support panels 16 can be selected to correspond with a user's body segments, aspects of the disclosure can be included wherein each of the set of support panels include a common length. The lengths illustrated in the figures are merely two non-limiting examples of lengths that are selectable for the customizing the set of support panels 16.

Aspects of the disclosure can be included wherein the base frame 12 can be made of metal, wood, or any other suitable material. The mattress 20 can be provided atop the base frame 12, and supported by the set of support panels 16.

FIG. 2 illustrates a bed frame assembly 30 shown without the base frame or legs, and wherein the set of support panels 16 are spaced above the bed frame assembly 30 to show a movable frame 13 in greater detail. The movable frame 13 is disposed within the base frame 12 (such as a stationary frame) and can be in the form of a singular piece designed to move in various directions, or can be in the form of a set of individual pieces 22 designed to move in various directions. The individual pieces 22 are parts of two longitudinal beams 21 that extend along the longitudinal axis X.

As used herein, the set of individual pieces 22 can be coupled such that movement of the set of pieces 22 or the movable frame 13 results in a movement of the pieces 22 or frame 13, respectively. In one non-limiting example, movement of the set of pieces 22 or the movable frame 13 can alter the configuration of the bed frame assembly 30 between an elevated position and a flat position. As used herein, an “elevated position” can include a raised head and feet section as seen in FIG. 3, while a “flat position” can include a substantially planar configuration of the set of support panels 16 or head and feet sections, as seen in FIG. 1.

Returning to FIG. 2, the movable frame 13 or the set of pieces 22 can include a metal construction, or any material having the desired properties of supporting the bed frame assembly 30, as described herein. The movable frame 13 can further comprise a set of mechanical fasteners 19, illustrated as bosses or posts, which can be configured to engage with or receive a corresponding set of mechanical couplers 18 disposes on the set of support panels 16, thereby removably or selectively coupling the support panels 16 to the movable frame 13.

The set of mechanical fasteners 19 can be in the form of a pin, rod, shaft, bolt, screw, or any suitable mechanical fastener configured to engage with the mechanical couplers 18 to engage in a selectable coupling mechanism. Different kinds of mechanical fasteners 19 can be combined, for example circular holes and slotted holes as well as the respective counterparts on the side of the support panels 16, and vice versa.

Preferably, the mechanical fasteners 19 allow a self-adjustment, for example by means of a conical shape. Hence, the support panels 16 can at first be applied with a comparable large lateral tolerance and are then aligned to precisely meet a first set of electrical connectors 24. Lateral tolerances between adjacent support panels 16 lie particularly in a range from at least 1 mm or 2 mm to at most 10 mm or 5 mm.

The set of mechanical couplers 18 can correspond with the set of mechanical fasteners 19, and include a screw interface, a twisting connector, a nut, and the like, such that the interfacing between the couplers 18 and fasteners 19 can be coupled.

FIG. 3 illustrates a configuration of the bed frame assembly 30 including a base frame 12, such as a stationary frame wherein the movement of the movable frame 13 or the set of individual pieces 22 have altered the bed into an elevated position, as described herein. The set of pieces 22 can, for instance, be hingeably coupled to the movable frame 13 and the support panels 16 such that relative movement of the movable frame 13 or the set of pieces 22 relative to the base frame 12 can elevate the head or foot sections, as illustrated. The set of pieces 22 can be coupled to either side of the set of support panels 16, and can allow the support panels 16 to be arranged in various positions.

Since the support panels 16 can have individual lengths, it is possible to create a wide variety of resulting shapes for the mattress 20 to conform to. For example, an individual support panel 16 that supports a user's head may be raised while an individual support panel 16 that supports a user's feet may be linear, that is parallel with the longitudinal beams 21 and directly on top of the longitudinal beams 21, compare FIG. 1. In another example, both the set of support panels 16 that support a user's head and feet may be raised. It is also within the scope of the disclosure to vary the height that an individual support panel 16 is raised from the linear position as well as the angle at which an individual support panel 16 is adjusted from the linear position.

Aspects of the disclosure can be included wherein a motor or a set of motors (not shown) are configured to move, actuate, or translate a portion of the bed frame assembly 30, the set of pieces 22, or a subset of pieces 22, or movable frame 13 relative to the base frame 12 to operably adjust the bed frame assembly 230 between the elevated position, the flat position, or any other adjustable positions therebetween or otherwise contemplated herein.

FIG. 4 provides a closer look at a portion of a bed frame 12 where the set of support panels 16 couple with the movable frame 13 or the set of pieces 22. The bed frame assembly 30 comprises the first set of bed frame connectors 24. The first set of connectors 24 can be disposed on the movable frame 13. The set of connectors 24 can be communicatively or conductively connected to a controller module 26. The controller module 26 or the first set of connectors 24 can further be connected to a power source, such as by way of the controller module 26. Also as shown, the mechanical fasteners 19 can be in the form of a conical pin having a threaded end in order to engage part 32.

While the communicative or conductive connection is illustrated in dotted outline apart from the bed frame assembly 12 for understanding, aspects of the disclosure can be included wherein, for example, cables, wiring, conductors, or the like, can be routed internal to the set of pieces 22 or the movable frame 13. It is also within the scope of the disclosure for the connectors 24, and the controller module 26 to be connected wirelessly.

The optional controller module 26 can further comprise a processor and memory. The memory can store a set of operational control profiles or programs for operation of the movable frame 13 or support panels 16 relative to the base frame 12, or for operation of a set of functional modules. The memory can include random access memory (RAM), read-only memory (ROM), flash memory, or one or more different types of portable electronic memory, such as discs, DVDs, CD-ROMs, etc., or any suitable combination of these types of memory. The controller module 26 can be operably coupled with the memory such that one of the controller module 26 and the memory can include all or a portion of a computer program having an executable instruction set for controlling the operation of the aforementioned components, or a method of operating the same.

The program can include a computer program product that can include machine-readable media for carrying or having machine-executable instructions or data structures stored thereon. Such machine-readable media can be any available media, which can be accessed by a general purpose or special purpose computer or other machine with a processor. Generally, such a computer program can include routines, programs, objects, components, data structures, algorithms, etc., that have the technical effect of performing particular tasks or implement particular abstract data types.

Machine-executable instructions, associated data structures, and programs represent examples of program code for executing the exchange of information as disclosed herein. Machine-executable instructions can include, for example, instructions and data, which cause a general purpose computer, special purpose computer, controller module 26, or special purpose processing machine to perform a certain function or group of functions. In implementation, the functions can be converted to a computer program comprising a set of executable instructions, which can be executed by the processor.

In one non-limiting configuration, the optional controller module 26 can be configured to receive instruction, to send control signals to a communicatively coupled device. For instances, the controller module 26 can operate in response to instructions received from another separate control module, including, but not limited to a remote control, a smart phone, or any other suitable device operable to send signals to the controller module 26. Aspects can be included wherein the separate controller module can be communicatively coupled with the controller module 26 by way of wired or wireless communication. The controller module 26 can be configured to selectively operate, control, or send control signals to other aspects or functionality of the bed frame assembly 12 or set of support panels 16.

By way of a non-limiting example, the processor or the controller module 26 can be configured to controllably operate the motors or set of motors to actuate the movable frame 13 or set of pieces 22 relative to the base frame 12. In another aspect of the disclosure, the processor or the controller module 26 can also be configured to controllably operate a set of functional modules configured to provide a function, service, or the like to the bed frame assembly, as described below.

FIG. 5 illustrates a second set of connectors 28 disposed on a bottom surface 15 of a base member 11 of the support panel 16, wherein the second set of connectors 28 can be configured to correspond or connect with the first set of connectors 24. The second set of connectors 28 is further connected with a functional module 34. The functional module 34 includes an identifier which can electronically be read out by means of the second set of connectors 28. When the support panel 16 is applied to the bed frame assembly 30 and the second connector 28 is inserted, the one or the more support panels 16 and the bed frame assembly 30 can communicate with each other to form an electronic network and by means of the identifier the support panels 16 and its functions can distinctly be identified. Other than shown, the identifier can be a separate component.

The second set of connectors 28 and the respective counterparts can be standardized components. That is, all kinds of support panels 16 available for the respective bed frame assemblies 30 can have compatible mechanical and electrical connectors and unique identifiers so that a simple change of support panels 16 can be achieved by an end-consumer.

As used herein, a functional module 34 provides an additional function to the support panel 16 or bed frame assembly 30. Examples of functional modules can include, but are not limited to a massaging or vibratory module, a heating module configure to generate or provide heat, a cooling element, a lighting element module configured to provide illumination relative to a room, floor, or bed frame assembly 30, a power supply module configured to supply power for an external component or connection (e.g. wall plug or universal serial bus (USB) plug), or a sensor module.

Moreover, the functional module 34 can be or can comprise a control unit. Such a control unit can be present on just one, on some or on all of the support panels 16. If there is a plurality of control units, a network can be formed in which the control units are interconnected by a bus system. Said bus system can also be a component of the functional modules 34. The at least one control unit can substitute the controller module 26.

Non-limiting aspects of the sensor module can include, for instance, a pressure sensor module configured to sense or measure pressure, a humidity sensor module configured to sense or measure humidity, or a temperature sensor module configured to sense or measure temperature. In another non-limiting aspect, the sensor module can be configured to provide or send the sensed or measured value(s) of the sensor module to the controller module 26, which can perform operations in response to the received sensed or measured value(s). The support panels can also be formed to provide additional support such as lumbar or head support by designing the panel to exhibit a desired structure or shape.

In the non-limiting illustrated example, the set of connectors 24, 28 can be correspondingly configured to include three connection points 36, but it is within the scope of the disclosure for the set of connectors 24, 28 to include any number of connection leads 36. The connection between the first and second set of connectors 24, 28 can provide bi-directional (i.e. two-way) or uni-directional (one-way) communication between the controller module 26 and the respective functional module 34. The communication can include digital or analog signals between the controller module 26 and the functional module 34. The connection and communication can also provide power to the functional module to operate, if needed.

Also shown, the set of mechanical couplers 18 of the support panels 16 can include a mechanical fastener receiving element 32, which are configured to receive the mechanical fasteners 19 of the movable frame 13 or set of pieces 22. The mechanical fastener receiving elements 32 to the connectors 28 can be arranged, configured, keyed, or the like such that assembling of the set of support panels 16 to the bed frame assembly 30 can only be accomplished in a known or predetermined orientation. Stated another way, the mechanical fastener receiving elements 32 or the second set of connectors 28 can be arranged to correspond with the bed frame assembly 30 to prevent errant or incorrect assembling.

For example, the spacing between adjacent fastener elements can be sized such that only a thigh-width support panel 16 can be selectively mounted with a corresponding thigh-width section on the movable frame 13, etc. In another non-limiting aspect of the disclosure, the first set of connectors 24 can be disposed on only one side of the bed frame 12, so the second set of connectors 28 of the support panel 16 can only be received in an orientation that corresponds with the one side of the bed frame 12. It is also contemplated that different functional modules can have different numbers of connectors 24, 28.

FIG. 6 illustrates one non-limiting example of the mechanical coupler 18 that is disposed on a top surface 17 of a support panel 16. The mechanical coupler 18 can operate to selectively couple or de-couple the support panel 16 to the movable frame 13 by way of a rotatable mechanical coupling or locking mechanism. The mechanical connector can be utilized by grasping a middle portion 40 and twisting or turning the mechanical coupler 18 to either release or engage a corresponding mechanical fastener 19 of the movable frame 13.

The mechanical fastener 18 can further operationally include indicia describing the clockwise or counterclockwise turning, and resulting locking/unlocking functionality, as shown. In one non-limiting configuration, a quarter turn or 90 degree rotation in the clockwise direction can operably lock or couple the support panel 16 to the movable frame 13, while a 90 degree rotation in the counter-clockwise direction can operably un-lock or decouple the support panel 16 from the movable frame 13. It is within the scope of the disclosure that the rotation require more or less than 90 degrees to lock or unlock the support panel 16 from the movable frame 13. Additionally, the clockwise or counter-clockwise turning direction can be selected to correspond with either the locking or unlocking operation, respectively.

The system architecture of the bed assembly 10 can thus be characterized as followed, in a preferred embodiment: The bed assembly comprises the base frame 12, the movable frame 13 and at least one of the support panels 16. For example, both longitudinal beams 21 of the bed have adjustable head and foot sections, realized by the support panels 16. The controller module 26 for all actuators, for example four actuators, in particular two in each one of the individual parts 22, is located in one of the individual parts 22 or in a first one of the longitudinal beams 21. The other, second longitudinal beam 21, without controller, is connected to the first longitudinal beam over a cable. A power supply is an external device which is connected to the first longitudinal beam 21 with the integrated controller module 26. Additional accessory modules like massage units, USB modules and the like can be connected to the controller module 26 with a special cable interface. The accessory modules can be mounted on the support panels 16 or on the base frame 12 itself or on the movable frame 13.

As an alternative, there is no central controller module but a decentral control architecture is applied: Each module like actuator modules, massage modules, USB ports, heating or cooling, remote control, sensors and so on comprise some logic components like integrated circuits so that no central controller module is necessary. In particular, each support panel comprises its own control unit. The support panels can communicate with each other, in particular by means of a bus system, in order to exchange system parameters like position, orientation, speed, temperature, pressure and so on. For this purpose, the support panels can directly be connected with each other by the bus system, or are indirectly connected by a bus system that runs via the bed frame assembly.

FIG. 7 shows an installation whereby the first electrical connector 24 is oriented towards the inner (or alternatively, outer) side of the bed assembly 10. The mechanical interface 18, 19 for the support panel fixation is on the top side of the frame member 12, 13. The controller module 26 is mounted on (or alternatively, integrated in) one of the two longitudinal beams 21. Further, motors 31 are connected to the controller module 26 by means of a respective cable management.

According to FIG. 8, the support panels 16 are provided with third electrical connectors 29. By means of the third electrical connectors 29, the support panels 16 can be connected in series along the longitudinal axis X. Moreover, in addition or as an alternative to the at least one second electrical connector 28, it is possible to have the identifier read out through the at least one third electrical connector 29. For example, the third electrical connectors 29 are designed as plug and socket. Hence, it is possible to have for example only one first electrical connector 24 at an end of only one longitudinal beam 21.

By means of such third electrical connectors 29, it is also possible to have a capacitive or inductive coupling between the support panels 16. Such a capacitive or inductive coupling could be contact-free so that the respective support panels 16 do not directly touch each other, neither at the base member 11 nor at the third electrical connectors 29. The same can be true for the electrical connection between the support panels 16 and the bed frame assembly 30. Otherwise, the support panels 16 could be in direct physical contact with each other, in particular just via the third electrical connectors 29. Further, the third electrical connectors 29 might be designed rotatory or gyratory in order to enable a rotational relative movement between the third electrical connectors 29 and/or the attached support panels 16. For example, in this case the connection between the third electrical connectors 29 includes a sliding contact.

Further, the bus system not necessarily needs to run via the bed frame assembly 30 or needs to directly contact adjacent support panels 16 with each other. For example, electrical signals are transmitted through a cloth cover like a duvet cover into which electrical conductor tracks are weaved. In this case, all support panels 16 can be cladded by the cover and are electrically connected with the cover. Said cover is then preferably in at least one location electrically connected to the bed frame assembly. Such weaved or printed or adhered conductor tracks can be accessibly at different locations in the cover. For example, the conductor tracks are accessible at pre-defined locations on the surface to enable the measurement of temperature, pressure and so on in or near said locations. The electrical connections between the cloth cover, the support panels 16 and the bed frame assembly 30 can be realized by physical contact or contact-free through capacitive or inductive coupling, too.

In short, the present invention is based inter alia on the following ideas:

Nowadays different functionalities of an adjustable bed frame are realized by dividing the portfolio in various product categories. The product is preassembled by the producer and cannot be extended, changed or modified to adjust different levels of features by the end user. Thus it is not possible to change the functionality without buying a new bed.

There are two different ways how adjustable frames are currently assembled. In one example, bed frame producers assemble the complete frame and send it in one piece or a single non-modifiable unit to the end consumer. Because of the heavy package (>70 kg) a home delivery service can be offered. In another example, end consumers can assemble the frame by themselves, which is a less-often occurrence compared with first example. That is, bed frame producers are splitting up the frame in two or more subassemblies and send them separately to the customer, who further assembles the subassemblies into the bed frame. A major drawback of this solution is the accessibility of some bed frame interfaces, such as the board (wooden panels) connection to the frame, are located on the bottom side of the bed frame. Thus, to access the bed frame interfaces, a flipping, lifting, or movement of the frame is required. In some examples, the panels are quite heavy and bulky, which when combined with the flipping, lifting, or movement of the frame, can require the assistance of a second person for the assembling.

Aspects of the disclosure include or consist of a combined mechanical-electrical interface between the solid frame and the boards of an adjustable frame. The interface is designed for end customer usage. This means that an unskilled person is able to connect and disconnect the boards to the frame. Electromechanical modules such as a control unit or massage actuators, which are preassembled on the bottom side of the boards, can be connected in the same assembling step to the cables within the frame. Thus, all relevant user interfaces are located on the top side of the boards it is not necessary to flip heavy components during the assembling.

Hence, the invention provides an end user friendly design in a modular system with regard to functional upgrades. Tool-less assembling and/or flip-less assembling is enabled so that in particular no flipping, lifting, or movement of the frame is required.

The support panels, also referred to as boards, are solid elements which can be divided into different sections, for example for a head, seat, thigh, foot. The board sections can further be adjusted by actuators located inside the frame. Additionally different modules like a control box, massage actuators, cable routing, and the like are preferably mounted on the bottom side of some boards. The frame is a solid structure for example of steel to carry or support the weight or loads coming from the boards. The boards are mounted to the frame via an electrical and mechanical interface.

Embodiments of the frame interface can include, but is not limited to, aspects such as compensation of mechanical tolerances, Poka-Yoke design in order to avoid user mistakes, protection against environmental influences like dust or humidity decoupling of electrical plug from mechanical force path, packaging and cable routing, or a combination thereof.

The support panel interface integrates the corresponding counterparts to the frame interfaces described above. It is worth to mention, that both the mechanical and the electrical interfaces are preferably designed in such a way that is possible to mount the boards from the top. The connection is then completed after a simple locking mechanism is fixed by the user. This procedure saves assembling time and gives the possibility to exchange boards, if an additional functionality like massage is desired, the user can unlock the board and substitute it by another board with the respective feature. In another example, a malfunctioning board can be exchanged for a new or functional board.

That is, the support panel can be an intelligent module and cable routing can be handled. The control unit can be mounted on the bottom side of the board. Cables can be guided to the electrical connector on the outer edge of the board. In one example, each electrical plug of the bed frame can be communicatively coupled with a bed control unit, a power supply, or the like. The bed control unit can further include a controller for a user having a user interface. In this sense, the bed frame can include a communicative pathway or network for the set of boards coupled by way of the set of electrical plugs, and wherein the set of boards can be controllably operated by at least one of the bed control unit, the user, or by the user interface.

Some options or configurations to be enabled by the replaceable support panels can include, but are not limited to:
Bed sizes: queen size, king size, twin long, and so on,
Adjustability: head up, head up+foot up, head up+foot up+wall hugging, lumbar support, and so on,
Comfort functions: massage, heating, headrest support, and so on,
Sensing: Processing can also be done in a smart device such as a smartphone, tablet or similar. For example, pressure, pinching events, temperature and so on can be sensed.
Optical appearance: colors, material, and so on.

By using the proposed interface, producers are able to split the product in common parts like the frame) and in customization parts like the support panels. This can help to simplify the supply chain and storage management and reduce the product variants by more than 50%.

In the exemplary embodiments, the support panel 16 is shown to have the massive base member 11. Instead, the support panel 16 can also be part of a lath floor, for example. The base member 11 does not necessarily need to be of continuous fashion but could also comprise cut-outs or through-holes, for example to enable sensors or the like.

The support panels 16 can also be delivered in a package. For example, the support panels 16 are covered by a cloth to cover openings or holes to improve a support of the mattress, to enhance the optical appearance and/or the design, to avoid accessibility of hinges, or to provide a bus system via the cloth.

To the extent not already described, the different features and structures of the various embodiments of the disclosure may be used in combination with each other as desired. For example, one or more of the features illustrated and/or described with respect to one of the embodiments can be used with or combined with one or more features illustrated and/or described with respect to the other of the embodiments.

That one feature may not be illustrated in all of the embodiments is not meant to be construed that it cannot be, but is done for brevity of description. Thus, the various features of the different embodiments may be mixed and matched as desired to form new embodiments, whether or not the new embodiments are expressly described. Aspects of the disclosure can be applied to any size of bed or bed frame, including but not limited to, queen, king, twin sizes, or the like.

The embodiments disclosed herein provide a bed frame assembly having interchangeable or module support panels that can include functional modules. The technical effect is that the above described disclosure enables the interchanging an operation of the functional modules by a common bed frame controller module or a decentral control concept, as well as enabling modular installation of support panels by a user, as opposed to a technical specialist. One advantage that can be realized in the above embodiments is that the above described embodiments have superior operable capabilities as regardless of the functional modules selected or installed with the bed frame assembly, the entire bed (as well as the functional modules) can all be controllably operated by a common controller module or control schema.

Another advantage of the above described disclosure is that the selective coupling and removing of the set of support panels enables a user to operably replace support panels as need to improve, update, increase, or modify the existing functionality of the bed with support panels having functional modules. In this sense, a user can customize their own bed frame assembly with support panels of their own choosing, assemble the bed frame assembly, and operate the bed frame assembly and functional modules by way of the common controller module. By enabling the modularity of the support panels, a user can effectively customize their own bed while limiting the handling, lifting, moving, or otherwise physical exertion of moving a large bed frame. In this sense, a single user can effectively customize their own bed without additional help.

The invention is not restricted to the exemplary embodiments by the description on the basis of said exemplary embodiments. Rather, the invention encompasses any new feature and also any combination of features, which in particular comprises any combination of features in the patent claims and any combination of features in the exemplary embodiments, even if this feature or this combination itself is not explicitly specified in the patent claims or exemplary embodiments.

### LIST OF REFERENCE SIGNS

10 bed assembly
11 base member
12 base frame
12a frame section
12b crossing portion
13 movable frame
14 leg
15 bottom surface of the support panel
16 support panel
17 top surface of the support panel
18 mechanical coupler
19 mechanical fastener
20 mattress
21 longitudinal beam
22 individual pieces of the frame section
24 first set of connectors
26 controller module
28 second set of connectors
29 third set of connectors
30 bed frame assembly
31 motor
32 engage part
34 functional module
36 connection point
40 middle portion
W length
X longitudinal axis

1. A support panel (16) comprising
a base member (11), the base member (11) being the mechanically stabilizing component of the support panel (16),
at least one mechanical coupler (18) on the base member (11),
at least one second electrical connector (28) located on the base member (11),
an identifier which can electronically be read out through the at least one second electrical connector (28), and
at least one functional module (34) selected from a sensor, an actuator, a control unit, an electrical link, and a power supply, mounted on or in the base member (11),
wherein the at least one mechanical coupler (18) and the at least one second electrical connector (28) are designed for reversible mechanical and electrical connection of the support panel (16) to a bed frame assembly (30), and
wherein a top surface (17) of the support panel (16), opposite to a bottom surface (15), is designed to be applied with a mattress (20).

2. The support panel (16) according to claim 1,
wherein the at least one mechanical coupler (18) as well as the at least one second electrical connector (28) are located on the bottom surface (15) and are configured as a plug connection, a clamping connection, or an insulation-displacement connection,
wherein the functional module (34) comprises at least one electrical link which is configured as a bus for bidirectional data transfer, and
the at least one mechanical coupler (18) as well as the at least one second electrical connector (28) enable a mechanical and electrical mounting of the support panel (16) in a direction parallel or orthogonal to the bottom surface (15), with a tolerance of at most 10°.

3. The support panel (16) according to claim 1,
wherein at least one of the mechanical coupler (18) and the second electrical connector (28) is in a Poka-Yoke design in order to avoid user mistakes when mounting the support panel (16).

4. The support panel (16) according to claim 1,
which is designed to be simultaneously electrically and mechanically connected.

5. The support panel (16) according to claim 1,
wherein the functional module (34) includes at least one of a massage module, a heating module, a cooling module, a wireless communication module, a lighting element module, a pressure sensor module, a humidity sensor module, or a temperature sensor module, a USB port, a squeeze protection module, a head rest support, a lumbar support, a microphone, an acceleration sensor, a biometrical sensor.

6. The support panel (16) according to claim 1,
wherein at least one of the mechanical coupler (18) and the second electrical connector (28) is accessible from the side of the top surface (17).

7. The support panel (16) according to claim 1,
further comprising a third electrical connector (29) designed to electrically connect two adjacent support panels (16) with each other and/or to electronically read out the identifier.

8. The support panel (16) according to claim 7,
wherein at least one of the second and the third electrical connectors (28, 29) is designed to be connected in a direction parallel with the bottom surface (15).

9. A bed assembly (10) comprising a bed frame assembly (30) and comprising at least one support panel (16) according to claim 1, the bed frame assembly (30) comprises
a base frame (12) having a longitudinal axis (X),
at least one longitudinal beam (21) extending along the longitudinal axis (X),
a plurality of mechanical fasteners (19) located on the at least one longitudinal beam (21), and
at least one first electrical connector (24) applied to the at least one longitudinal beam (21),
wherein the at least one support panel (16) is reversibly mechanically connected to the at least one longitudinal beam (21) by means of at least one of the mechanical fasteners (19) and the at least one mechanical coupler (18), and
wherein the at least one support panel (16) is reversibly electrically connected to the at least one longitudinal beam (21) by means of the at least one first and second electrical connectors (24, 28).

10. The bed assembly (10) according to claim 9,
wherein the mechanical fastener (19) and the mechanical connector (18) as well as the first and second electrical connectors (24, 28) are designed as plug-in devices to be handled without any help of tools.

11. The bed assembly (10) according to claim 9,
further comprising a central controller module (26),
wherein the controller module (26) is designed to provide electrical power and control signals to the at least one first electrical connector (24) and to the at least one support panel (16), and
wherein the controller module (26) is firmly connected on the base frame (12).

12. The bed assembly (10) according to claim 9,
comprising a plurality of the support panels (16),
wherein at least two of the support panels (16) comprise the functional module (34) which includes the control unit and the electrical link, and
wherein by the at least two control units and the corresponding electrical links a decentral control network is formed.

13. The bed assembly (10) according to claim 9,
wherein the first and second electrical connectors (24, 28) are integrated with the mechanical fastener (19) and the mechanical connector (18), respectively.

14. The bed assembly (10) according to claim 9,
comprising a plurality of the support panels (16),
wherein adjacent support panels (16) are electrically interconnected via the at least one longitudinal beam (21), by means of an electrical plug or an electrical cable directly between the respective support panels (16), or by means of a cloth cover comprising electrical conductor tracks.

15. The bed assembly (10) according to claim 9,
wherein a plurality of first electrical connectors (24) is applied to each one of the at least two longitudinal beams (21),
wherein the longitudinal beams (21) each comprise a plurality of individual pieces (22), at least some of the individual pieces (22) being electrically movable by actuators relative to the base frame (12),
wherein each one of the individual pieces (22) is provided with at least one of the mechanical fasteners (19),
wherein each one of the individual pieces (22) of at least one of the longitudinal beams (21) is provided with at least one of the first electrical connectors (24), and
wherein the at least one support panel (216) is mounted on at least one of the individual pieces (22) for each longitudinal beam (21) so that the at least one support panel (16) is movable via the respective individual pieces (22).

16. Mounting method comprising the following steps:
providing a bed frame assembly (30) having one or a plurality of dummy support panels,
removing the or at least one of the dummy support panels,
providing at least one support panel (16) according to claim 1, and
mounting the at least one support panel (16) reversibly onto the bed frame assembly (30) so that the bed assembly (10) according to one of claims 9 to 15 results and so that the dummy support panel is replaced by the at least one support panel (16),
wherein the removing of the dummy support panel and mounting the at least one support panel (16) is done without the use of tools.
